(19) United States
(12) Patent Application Publication
(10) Pub. No.: US 2008/0196843 A1
(43) Pub. Date: Aug. 21, 2008

(54) Rail structure for window blinds

(75) Inventors: Ming Nien, Lugang Township (TW); Yu-Che Wen, Gueishan Township (TW); Ju-Sheng Cheng, Taichung City (TW); Oliver Chiu, Taichung City (TW)

Correspondence Address: RABIN & Berdo, PC, 1101 14TH STREET, NW, SUITE 500, WASHINGTON, DC, 20005, US

(73) Assignee: Nien Made Enterprise Co., Ltd., Taichung City (TW)

(21) Appl. No.: 11/882,518

(22) Filed: Aug. 2, 2007

(30) Foreign Application Priority Data
Feb. 15, 2007 (CN) 200720005768.3
Jul. 12, 2007 (CN) 200720150896.7

(51) Int. Cl. E06B 9/266; E06B 9/24

(52) U.S. Cl. 160/178.1 R; 160/168.1 R

(57) ABSTRACT

A rail structure for window blinds is provided, which includes a body and at least one connecting member. The body has a pair of first flanges and a pair of second flanges. The first flanges are disposed on tops of two sides of the body, and the second flanges are disposed on bottoms of the two sides of the body. In addition, the connecting member is mounted to an outer surface of one side of the body, has a predetermined shape of constant cross-section profile, a length and a width, Besides, a flange is disposed on a predetermined position of the connecting member and extending to one side of the body. By the connecting members, the headrail appearance can be enhanced. Moreover, as the connecting members do not directly bear the overall or partial weight of the window blind, the rail structure can have an extended product lifetime.

This application claims the benefit of P.R.China patent application No. 200720005768.3, filed on Feb. 15, 2007 and P.R.China patent application No. 200720150896.7, filed on Jul. 12, 2007, which are hereby incorporated by reference for all purposes as if fully set forth herein.

### BACKGROUND OF THE INVENTION

1. Field of Invention

The present invention relates to a rail structure for window blinds, and more particularly, to a rail structure having decorative outerlayers.

2. Related Art

According to prior arts, window blinds normally include a headrail and a bottomrail. The bottomrail is disposed below the headrail and controlled by means of pulling cords to move in a vertically upward or downward motion. The blind slat is disposed between the headrail and the bottomrail, and it can be stacked, extended, or tilted in accordance to the movement of the bottomrail.

The window blinds usually are fastened on walls or ceiling by brackets. For adding aesthetic appeal, there are several ways to be taken: First, an opening is disposed on outer wall of a headrail, and a decorative valance is inserted into the opening, such as disclosed in U.S. Pat. No. 4,742,860. However, this arrangement suffers from a disadvantage, the headrail and brackets are partially exposed; therefore, it can't have an attractive appearance. Second, a valance is hung on outer side of the headrail to hide headrails and brackets, such as disclosed in U.S. Pat. No. 5,944,084. Third, a decorative device is disposed and mounted on walls or ceiling to conceal headrails, such as disclosed in U.S. Pat. No. 5,330,821. Nevertheless, the total cost for manufacturing second and third arrangements are relatively higher, and they usually leave a gap between the valance and the headrail.

### SUMMARY OF THE INVENTION

In view of the above problems of the conventional art, the present invention provides a rail structure for window blinds. Particularly, it can be applied to headrails of window blinds. The object of the present invention is to further enhance the overall aesthetic appearance for window blinds.

One embodiment of the present invention is to provide a rail structure for window blinds, which has a decorative connecting member disposed on the adequate positions of a rail, and can be totally exposed or partially exposed.

In the rail structure for window blinds of the present invention, the decorative connecting member does not connect with any other element to directly support the overall weight of the headrail, so that the connecting member will not incidentally break away from the headrail.

When the rail is arranged as a headrail, it has a first supporting member, a second supporting member, and a connecting member. The first supporting member and the second supporting member are generally spaced apart with a predetermined distance. In practice, either the hanging type or alternatively the fixing type of the valance can be used in conjunction with the rail structure of the present invention.

When the rail is arranged as a bottomrail, it has a third supporting member and a covering layer masked thereon; when the rail is acted as a middlerail, it has the same structure resembled to the bottomrail.

The first and second supporting members can be incorporated to form an H-shaped structure to simplify the manufacturing process. Conveniently, both side walls along the longitudinal axis of the headrail can be interchangable to be used as the front surface of the window blinds, so that the rail structure got greater flexibility in practical usage.

One embodiment of the present invention is to provide a rail structure for window blinds. The rail structure for window blinds comprises a headrail and a bottomrail, and the bottomrail is connected with the headrail by means of a plurality of pulling cords. The pulling cords are used to control the movement of the bottomrail in relative upward and downward movement; in addition, at least one blind slat is disposed therebetween the headrail and the bottomrail.

The headrail is composed of a body and a pair of connecting members. The body has a predetermined length and width, and an upward opening and a downward opening. The pair of connecting members is respectively mounted with front surface and back surface of the body. Besides, lower end of the connecting member has an inwardly extending flange along the longitudinal axis. The flange is located beneath the body so as to fully conceal the front surface, back surface and rest portions of the lower body.

The present invention provides numerous advantages in practical usage, which not only enhances the exterior appearance of the blind headrail by means of exposed connecting members, but it also extends the product rigidity and lifetime as the body of the connecting members which is fully concealed and positioned at interior of the connecting members will bear the overall weight of the corresponding portions of the window blind, so that such connecting member is less likely to be damaged or marred in any circumstance.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, which thus is not limitative of the present invention, and wherein:

FIG. 1 is a schematic structural view of a first embodiment of the present invention;

FIG. 2 is a schematic structural view of a second embodiment of the present invention;

FIG. 3 is a schematic structural view of a third embodiment of the present invention;

FIG. 4 is a stereo view of the third embodiment of the present invention; and

FIG. 5 is a schematic structural view of a headrail of a fourth embodiment of the present invention.

### DETAILED DESCRIPTION OF THE INVENTION

Further objectives, structures, and functions of the present invention will be more apparent from the following embodiments with reference to the accompanying drawings.

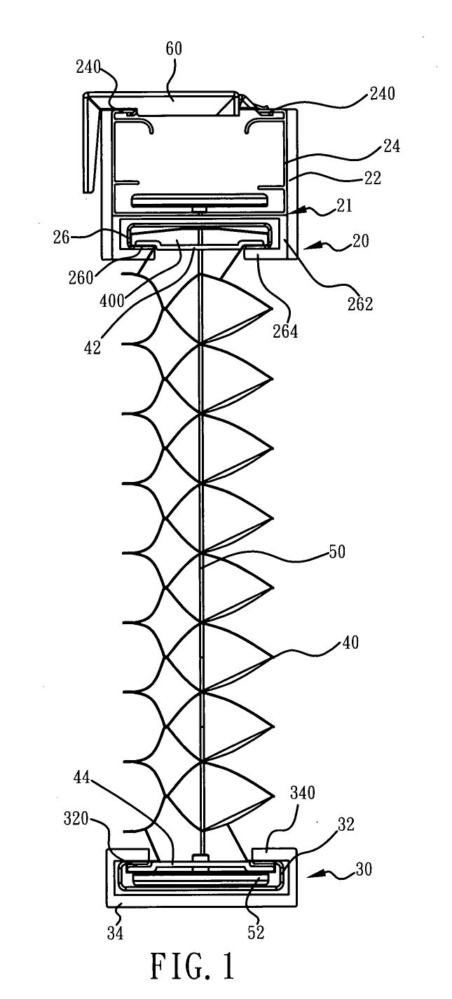

As shown in FIG. 1, it is a schematic structural view of a first embodiment of the present invention. Cellular shades are taken as examples in this embodiment. The rail structure comprises a headrail 20, a bottomrail 30, and a cellular shade 40. The bottomrail is disposed below the headrail 20, and the cellular shade 40 is disposed between the headrail 20 and the bottomrail 30. In addition, a plurality of pulling cords 50 are connected to between the headrail 20 and the bottomrail 30 and substantially passing through the entire cellular shade 40, so as to control the upward and downward movement of the bottomrail 30 and thusly fix the position of the bottomrail 30 thereon.

The headrail 20 comprises a body 21 composed of a first supporting member 24 and a second supporting member 26, and a pair of connecting members 22 respectively mounted to a front surface and a back surface of the body 21.

The first supporting member 24 is disposed on an upper portion of the headrail 20 and has an upward opening. Besides, the constant cross-section profile of the first supporting member 24 is U-shaped. The outer edge of the first supporting member 24 is connected with inner walls of the two connecting members 22 respectively. The first flanges 240 are respectively disposed on top ends of front and back side walls of the first supporting member 24, and faced one another to substantially extend into an adequate width as to coordinate with a hanger 60 to fasten the headrail 20 upon the walls or ceiling.

The second supporting member 26 is disposed on a lower portion of the headrail 20 and has a downward opening. Besides, the constant cross-section profile of the second supporting member 26 is reversely U-shaped. A pair of second flanges 260 is protruding and disposed on a lower end of front and back sides of the second supporting member 26, and they are facing one another extended for an adequate width, respectively. Besides, a first covering layer 262 is disposed on outer surfaces of the second supporting member 26, and connects to inner walls of each connecting member 22 and lower edges of the first connecting member 24 respectively, so that they can form a corresponding H-shaped structure with the first supporting member 24. Lower ends of two sides of the first covering layer 262 have a protruded bent-upward portion 264 respectively, and the two bent-upward portions 264 are facing each other and corresponding to the places where are just under the second flanges 260.

The bottomrail 30 comprises a third supporting member 32 resembled to an U-shaped structure and forms an extended third flange 320 in both ends of front and back sides of the third supporting member 32 with an adequate width. And the two third flanges are facing one another. Outer surfaces of the bottomrail 30 are disposed with a second covering layer 34 having an upward opening. The shapes of the third supporting member 32 and the second supporting member 26 with a first covering layer 262 are symmetrical with respect to each other in a relative up and down direction.

The uppermost cell 400 of the cellular shade 40 has an upper plate 42 disposed therein and both are positioned altogether within the second supporting member 26. The upper plate 42 has an adequate width with two ends hindered by the respective second flange, so that the cellular shade 40 can be overhung and mounted below the headrail 20. And lower portions of the cellular shade 40 can be hung and mounted onto the bottomrail 30 by the same means of a lower plate 44 using the same assembling method.

Each pulling cord 50 has a suitable length, and partial length of pulling cord is extending to between the headrail 20 and the bottomrail 30. Besides, lower ends of the pulling cord 50 are fixed to a fastener 52, and the fastener 52 has an adequate width and is disposed on the third supporting member 32. In addition, the fastener 52 is hindered by the third flanges 320, so that the fastener 52 will not accidentally break away from the bottomrail 30.

The disposition of the second covering layer 34 can further enhance the exterior appearance of the bottomrail 30, and top ends of two sides of the second covering layer 34 has a bent-downward portion 340 respectively. The two bent-downward portions are facing each other and used to fully conceal the top of each third flange. In addition, each second supporting member 26, third supporting member 32, and the first and second covering layers (262, 34) covered thereon can be relatively assembled in a symmetric manner so as to reduce number of varying parts need to be retained in inventory. Moreover, each first and second covering layer (262, 34) can be respectively connected with the first, second, and third supporting members (24, 26, and 32) by means of glue.

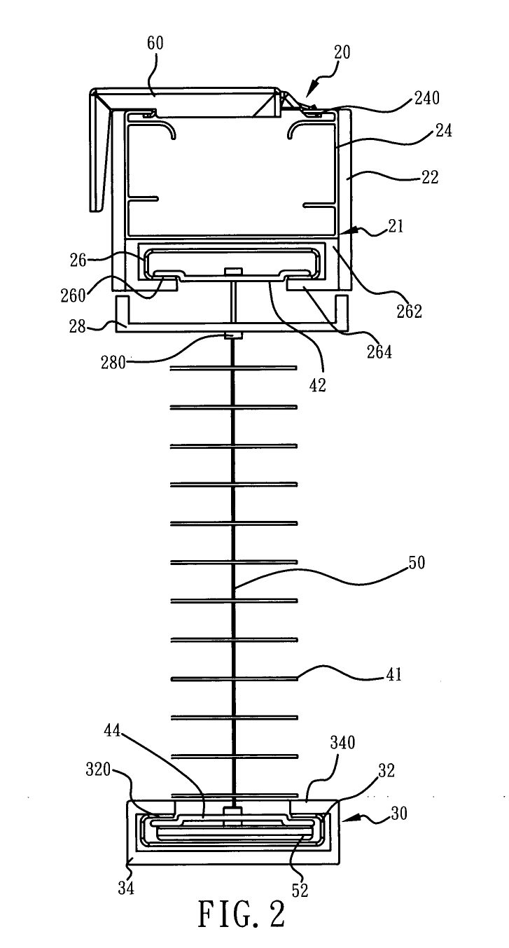

Referring to FIG. 2, it discloses a structure of window blinds. In the second embodiment, the structures of the headrail 20 and the bottomrail 30 are exactly resembled to the first embodiment. Wherein, a plurality of pulling cords 50 are connected to between the headrail 20 and the bottomrail 30, and passing through each blind slat 41 therebetween so as to enhance the exterior appearance of the window blinds. Besides, a cover plate 28 is added to below the headrail 20 and mounted with the plate 42 by means of mounting bolts 280.

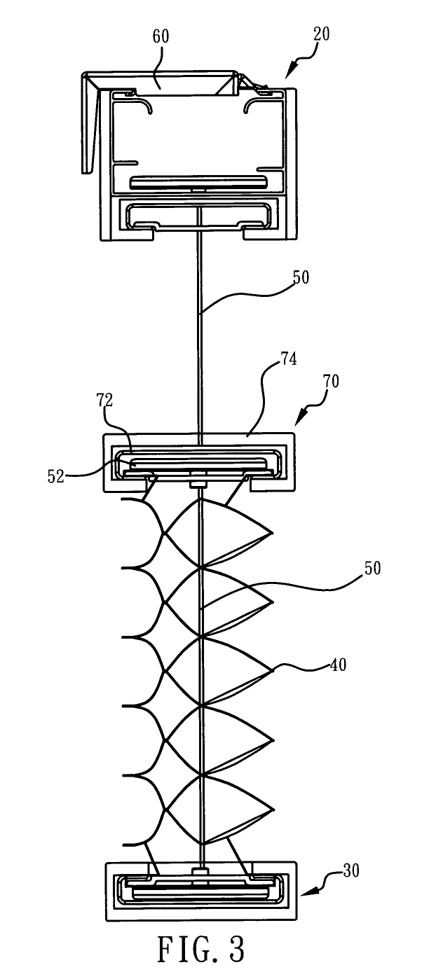

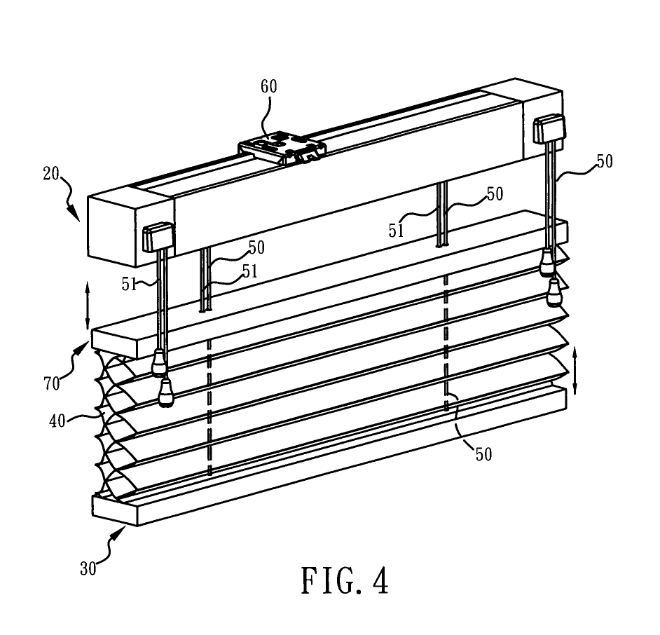

Referring now to FIGS. 3 and 4, it is a schematic structural view of a third embodiment of the present invention. A top-down bottom-up (TDBU) window shade is taken as an example. The TDBU window shade has a structure resembling to the first embodiment. However, it further comprises a middlerail 70 disposed between the headrail 20 and the bottomrail 30, and the middlerail 70 can have free movement in vertically upward and downward directions.

The middlerail 70 has a fourth supporting member 72 with a reversely U-shaped structure, and a third covering layer 74 covered outer surfaces of the fourth supporting member 72. The structure of the middlerail 70 and the structure of the bottomrail 30 are symmetrical with respect to each other in top and bottom orientations. The cellular shade 40 is disposed therein between the middlerail 70 and the bottomrail 30.

Part of each individual pulling cord 50 is extending through and between the headrail 20 and bottomrail 30, and there are several pulling cords 51 respectively wound between the headrail 20 and the middlerail 70 as well. And a plurality of fastener 52 corresponding to the number of pulling cords are disposed in the fourth supporting member 72 therein, so as to effect the vertically upward and downward motion of the middlerail 70.

In use, if one attempts to position the middlerail 70 and the second supporting member 26 with the first covering layer 262 in symmetrical relation with respect to one another in up and down orientations, the cellular shade 40 can therefore be installed therebetween the headrail 20 and the middlerail 70. With the same manner, when two middlerails are disposed, the cellular shade 40 can also be respectively installed therebetween the headrail 20 and the middlerail 70 and between the middlerail 70 and the bottomrail 30 (not shown).

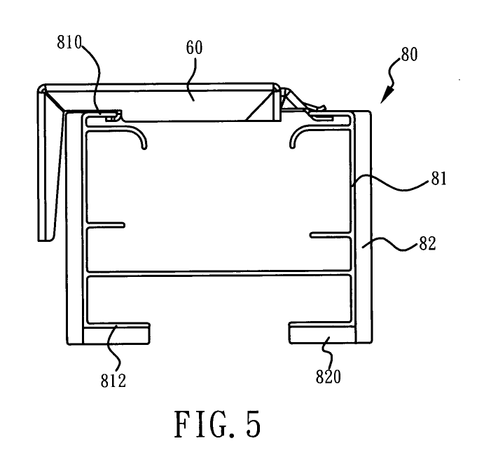

Referring to FIG. 5, it is a structure of a headrail of a fourth embodiment of the present invention. The headrail 80 comprises a body 81 and a pair of connecting members 82. The boy has an H-shaped similarity, and a pair of first flanges 810 and a pair of second flanges 812 are inwardly extending into a predetermined width from respective top and bottom ends of two associated sides of the body 81. Still, the pair of connecting members 82 is respectively connected to front and rear surfaces of the body 81.

Besides, each bottommost end of the connecting member 82 has a fourth flange 820, and each fourth flange 820 is extending along the longitudinal orientation of the connecting member 82. Also, each fourth flange 820 has a predetermined width, so as to be fully concealed under the second flange 812; therefore, the body 81 made of metal materials would not be exposed.

Consequently, the supporting members (24, 26, 32, and 72) and the body 81, that are made of metal materials, can bear the overall weight or partial weight of the window blind. This feature, coupled with the connecting member 22 and the associated covering layer will substantially enhance the exterior appearance of the window blinds. As each connecting member 22 with the covering layer is not directly constructed and arranged to bear the overall weight of the window blind, the product lifetime of such connecting member is thusly relatively extended and the connecting member may be made from real wood with inherently wood-grain appearance.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A rail structure for window blinds, comprising:
at least one connecting member, having a predetermined shape of cross-section profile, a length, and a width;
a first supporting member having a predetermined length and an opening extending along a longitudinal axis of the first supporting member, one side of the first supporting member corresponding to front side of a window blind and capable of being connected with the connecting member;
a second supporting member having a predetermined length and an opening extending along a longitudinal axis of the second supporting member, one side of the second supporting member corresponding to the front side of the window and capable of being connected with the connecting member, the first supporting member and the second supporting member being spaced apart from one another in a predetermined distance.

2. The rail structure for window blinds as claimed in claim 1, wherein two connecting members are further comprised, the first and second supporting members corresponding to the respective front and rear surfaces of the window blind are mounted to the interior of the connecting members accordingly.

3. The rail structure for window blinds as claimed in claim 1, further including a first covering layer disposed among outer surface of the second supporting member and inner surfaces of the respective first supporting member and the connecting member.

4. The rail structure for window blinds as claimed in claim 3, wherein two sides of the second supporting member adjacent to the opening having a respective second flange, the first covering layer having a pair of upwardly bowing portions corresponding to lower portion of each second flange.

5. The rail structure for window blinds as claimed in claim 1, further comprising a bottomrail having a third supporting member with an upward opening, a pair of third flanges disposed on two sides of the bottomrail adjacent to the opening, a second covering layer disposed on outer surface of the third supporting member, and a pair of downwardly bowing portions corresponding to top portions of each third flange.

6. A rail structure for window blinds, comprising:
a body, having a H-shaped structure and a pair of first flanges respectively disposed on top ends of two sides of the body and another pair of second flanges respectively disposed on bottom ends of the two sides of the body; and
a pair of connecting members, having a respective predetermined shape of constant cross-section profile and a flange mounted upon outer edges of two sides of the body, and each flange being disposed on a predetermined position of the connecting member and substantially extended therefrom and to the lower surface of the two sides of the body.

7. A window blind structure, comprising:
a headrail, including a body providing a H-shaped structure, and having a pair of first flanges disposed upon top ends of two sides of the body respectively and a another pair of second flanges disposed on bottom ends of the two sides of the body respectively;
at least one connecting member, having a predetermined shape of cross-section profile, a length and a width which being connected to outer edge of one side of the body, and a flange being disposed on a predetermined position of the connecting member and substantially extended therefrom and to a lower end of one side where the body and the connecting member being connected;
a bottomrail, disposing below the headrail;
a plurality of pulling cords, being wound to and between the predetermined positions of the headrail and the bottomrail, so as to control the movement of the bottomrail in a relative upward and downward motion; and
at least one blind slat, disposing between the bottomrail and the headrail.

8. The window blind structure as claimed in claim 7, further comprising a middlerail, the blind slat being disposed between the headrail and the middlerail and/or between the middlerail and the bottomrail.

9. The window blind structure as claimed in claim 7, wherein the bottomrail including a third supporting member with an upward opening and a covering layer disposed on outer surfaces of the third supporting member, and the covering layer having an open end corresponding to outer side of the upward opening.

10. The window blind structure as claimed in claim 7, wherein the middlerail including a fourth supporting member with an downward opening and a covering layer disposed on outer surfaces of the fourth supporting member, and the covering layer having an open end corresponding to outer side of the downward opening.

11. The window blind structure as claimed in claim 7, wherein shapes of the middlerail and the bottomrail are symmetrical with one another in a relative up and down position.

12. The window blind structure as claimed in claim 7, wherein the third supporting member being U-shaped and having a pair of flanges, the flanges respectively disposed on two sides of the third supporting member adjacent to the upward opening and paralleled extending with respect to one another along a longitudinal axis, and at least one fastener being used to connect with one end of at least one pulling cord, the fastener having a predetermined width which is disposed at interior of the third supporting member, thusly the two opposite-sided surfaces of the fastener being located at lower portions of each flange.
